(19) United States
(12) Patent Application Publication
(10) Pub. No.: US 2025/0248457 A1
(43) Pub. Date: Aug. 7, 2025

(54) ELECTRONIC CIGARETTE WITH DETACHABLE BATTERY

(71) Applicant: CHENJING LIAO, Shenzhen (CN)

(72) Inventor: CHENJING LIAO, Shenzhen (CN)

(21) Appl. No.: 18/433,698

(22) Filed: Feb. 6, 2024

(51) Int. Cl. A24F 40/90; A24F 40/10; A24F 40/42; A24F 40/48; A24F 40/51; A24F 40/60; H01M 50/202; H01M 50/247; H01M 50/284

(52) U.S. Cl. CPC A24F 40/90; A24F 40/10; A24F 40/42; A24F 40/48; A24F 40/51; A24F 40/60; H01M 50/202; H01M 50/247; H01M 50/284; H01M 2220/30

(57) ABSTRACT

The present disclosure provides to an electronic cigarette with a detachable battery, including: a shell, a cavity that runs through two ends is provided in the shell, one end of the shell is provided with a suction nozzle, the other end thereof is detachably provided with an end cover; an atomization mechanism, the atomization mechanism is located at one side of the cavity close to the suction nozzle, the atomization mechanism is connected to the suction nozzle; a power supply mechanism, the power supply mechanism is provided in the cavity and is electrically connected to the atomization mechanism; after disassembling the end cover, the atomization mechanism and the power supply mechanism can slide out from the cavity of the shell, and the end cover abuts against the power supply mechanism to fix the atomization mechanism and the power supply mechanism in the cavity of the shell.

### TECHNICAL FIELD

The present disclosure belongs to the field of electronic cigarette, and in particular, to an electronic cigarette with a detachable battery.

### BACKGROUND

As an electronic product, the electronic cigarette provides power to an atomization core through a power supply, the atomization core is caused to generate heat and atomize a tobacco tar, thus an effect of simulating a feeling and taste of a traditional cigarette is achieved. Compared to the traditional cigarette, the electronic cigarette has no open fire or ash, rendering it safer and cleaner, and is highly favored by consumers.

However, as an electronic product, a continuous operation market of the electronic cigarette is often limited by the power supply. After the battery is low, a user often needs to wait for the electronic cigarette to charge before continuing to use, a waiting process greatly affects a user experience. In order to shorten charging time and optimize the user experience. In existing technologies, a fast-charging method such as increasing charging current and power is used to reduce the charging time. However, this method requires higher requirements for charging circuits and batteries, which will increase a product cost; on the other hand, a larger charging current can cause a significant heat generation, have safety hazards, and cannot meet a long-term outdoor usage need.

### SUMMARY

A purpose of the present disclosure is to provide a detachable battery electronic cigarette that addresses the shortcomings of the existing technology. By using a detachable and replaceable battery to render the battery can be used multiple times, a user's perception of charging time is reduced, and an outdoor battery life is improved.

In order to achieve the above objectives, the present disclosure adopts the following technical solutions.

An electronic cigarette with a detachable battery, including:
a shell, which is provided with a cavity that runs through two ends, one end of the shell is provided with a suction nozzle, the other end thereof is detachably provided with an end cover;
an atomization mechanism, the atomization mechanism is located at one side of the cavity close to the suction nozzle, the atomization mechanism is connected to the suction nozzle;
a power supply mechanism, the power supply mechanism is provided in the cavity and is electrically connected to the atomization mechanism;
after disassembling the end cover, the atomization mechanism and the power supply mechanism can slide out from the cavity of the shell, and the end cover abuts against the power supply mechanism to fix the atomization mechanism and the power supply mechanism in the cavity of the shell.

In an embodiment of the present disclosure, the atomization mechanism includes an oil storage bin, an atomization core, and an atomization channel, where the atomization core is connected to the atomization channel and the oil storage bin;
one side of the atomization mechanism close to the suction nozzle is provided with a smoke outlet, one side of the atomization mechanism close to the power supply mechanism is provided with an air inlet; the atomization channel is connected to the smoke outlet and the air inlet.

In an embodiment of the present disclosure, the oil storage bin is made of a transparent material, the shell is provided with a visible window, a position of the visible window corresponds to a position of the oil storage bin.

In an embodiment of the present disclosure, a conductive pin of the atomization core extends out of the atomization core and abuts against an electrode of the power supply mechanism to form conductivity, the end cover abuts against the power supply mechanism to maintain a connection between the electrode of the power supply mechanism and the conductive pin.

In an embodiment of the present disclosure, the power supply mechanism includes:
a power supply housing;
a battery cell, where the battery cell is provided in the power supply housing;
a control board, where the control board is provided in the power supply housing;
where the control board is provided with a charging port, the power supply housing is provided with a through hole corresponding to the charging port.

In an embodiment of the present disclosure, the control board is provided with an air outlet, and the air outlet is connected to the through hole on the power supply housing to form a first air passage;
the control board is provided with an airflow sensor, the airflow sensor is located in the first air passage to monitor airflow; the control board controls an external power supply of the power supply mechanism according to signal of the airflow sensor.

In an embodiment of the present disclosure, the end cover is provided with an air hole;
a gap is formed between the shell and the atomization mechanism with the power supply mechanism; the gap connects the air hole and the through hole on the power supply housing to form a second air passage.

In an embodiment of the present disclosure, the air hole of the end cover is inwardly recessed.

In an embodiment of the present disclosure, a type of the charging port is type-c.

In an embodiment of the present disclosure, one side of the shell close to the end cover is provided a fixed ring with a bending groove, the end cover is located at an ear portion of the bending groove; the end cover is detachably connected to the shell by the ear portion matching with the bending groove.

The technical solution of the present disclosure has the following advantages compared to existing technologies:
1. Adopting a detachable and replaceable battery allows a user to use multiple batteries in turn, reducing his perception of charging time. When the battery is low, the user can replace the battery without waiting for charging, thereby improving a user experience.
2. A design of a detachable battery avoids safety hazards caused by high charging current and power. Due to a use of multiple batteries in turn, a lifetime of the battery has also been effectively extended, thereby improving a durability of the electronic cigarette.
3. With the design of a detachable battery, the user can carry multiple backup batteries, which can last longer when used outdoors, thereby meeting a need of long-term outdoor use.

The other features and advantages of the present disclosure will be elaborated in the specification, and it will be partially apparent from the specification or understood through the implementation modes of the present disclosure. The purpose and other advantages of the present disclosure can be achieved and obtained through the structure specifically pointed out in the specification and drawings.

### BRIEF DESCRIPTION OF DRAWINGS

The following is a detailed description of the present disclosure in conjunction with the drawings, in order to render the above advantages of the present disclosure more clear.

FIG. 1 is a schematic diagram of an electronic cigarette with a detachable battery of the present disclosure.

FIG. 2 is an exploded view of the electronic cigarette with a detachable battery of the present disclosure.

FIG. 3 is an exploded view of an atomization mechanism of the electronic cigarette with a detachable battery in the present disclosure.

FIG. 4 is a schematic diagram of the atomization mechanism of the electronic cigarette with a detachable battery of the present disclosure.

FIG. 5 is an internal diagram of a power supply mechanism of the electronic cigarette with a detachable battery of the present disclosure.

FIG. 6 is a schematic diagram of an airflow of the power supply mechanism of the electronic cigarette with a detachable battery of the present disclosure.

FIG. 7 is a schematic diagram of an assembly of an end cover of the electronic cigarette with a detachable battery in the present disclosure.

### DESCRIPTION OF EMBODIMENTS

The following describes in detail the embodiments of the present disclosure, examples of embodiments are shown in the drawings, identical or similar references throughout represent identical or similar components or elements with identical or similar functions. The embodiments described below with reference to the drawings are exemplary and intended to explain the present disclosure, but cannot be understood as limitations to the present disclosure.

In the description of the present disclosure, it should be understood that terms “length”, “width”, “up”, “down”, “front”, “back”, “left”, “right”, “vertical”, “horizontal”, “top”, “bottom”, “inside”, “outside”, etc. indicate an orientation or position relationship based on the orientation or position relationship described in the drawings, only for a convenience of describing the present disclosure and simplifying the description, and not to indicate or imply that the device or component referred to must have a specific orientation, be constructed and operated in a specific orientation. Therefore, it cannot be understood as a limitation on the present disclosure.

In addition, terms “first” and “second” are only used to describe a purpose and cannot be understood as indicating or implying a relative importance or implying the quantity of technical features indicated. Therefore, features limited to “first” and “second” can explicitly or implicitly include one or more of these features. In the description of the present disclosure, “multiple” means two or more, unless otherwise specified.

In the embodiments of the present disclosure, unless otherwise specified and limited, terms “installation”, “connection to”, “connection with”, “fixation” and other terms should be broadly understood, for example, they can be a fixed connection, a detachable connection, or an integrated connection; it can be a mechanical connection or an electrical connection; it can be a direct connection or an indirect connection through an intermediate medium, which can be the internal connection of two components or the interaction relationship between two components. For ordinary technical personnel in this field, specific meanings of the above terms in the present disclosure can be understood based on a specific circumstance.

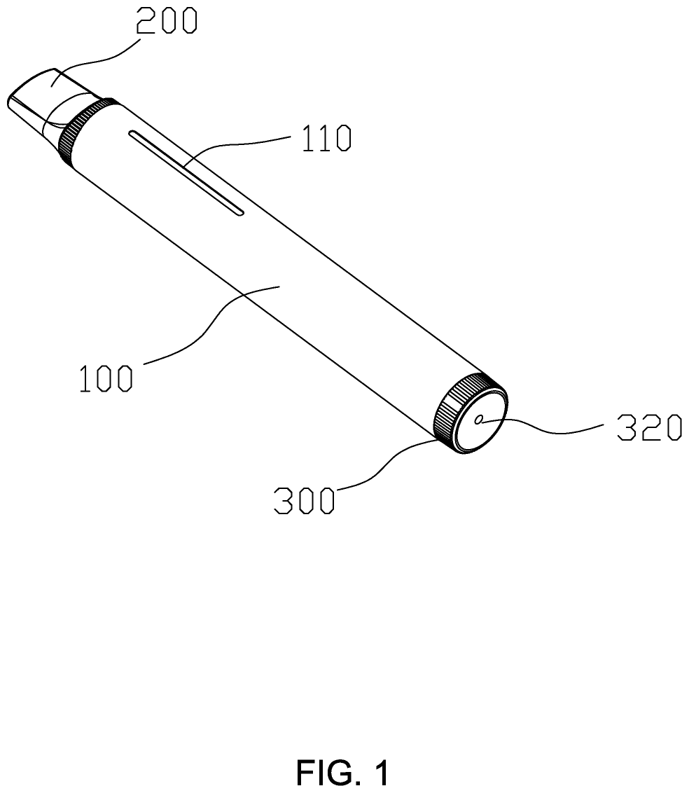

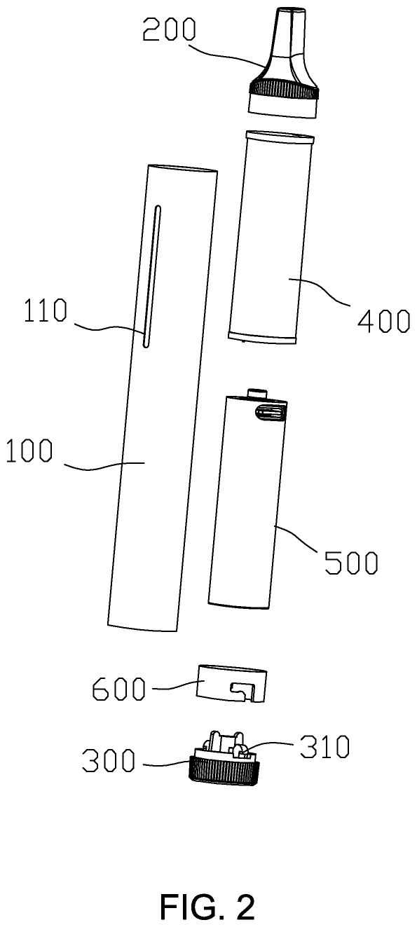

Referring to FIGS. 1-2, an electronic cigarette with a detachable battery including:
a shell 100, which is provided with a cavity that runs through two ends, one end of the shell 100 is provided with a suction nozzle 200, the other end thereof is detachably provided with an end cover 300;
an atomization mechanism 400, which is located at one side of the cavity close to the suction nozzle 200, and is connected to the suction nozzle 200;
a power supply mechanism 500, which is provided in the cavity and is electrically connected to the atomization mechanism 400;
after disassembling the end cover 300, the atomization mechanism 400 and the power supply mechanism 500 can slide out from the cavity of the shell 100. The end cover 300 abuts against the power supply mechanism 500 to fix the atomization mechanism 400 and the power supply mechanism 500 in the cavity of the shell 100.

By adopting a detachable and replaceable power supply mechanism 500, a user can use the power supply mechanism 500 multiple times, reducing his perception of charging time. When the power supply mechanism 500 runs low, the user can replace it without waiting for charging, thereby improving a user experience. A design of the detachable power supply mechanism 500 avoids safety hazards caused by high charging current and power. Due to a use of multiple power supply mechanisms 500 in turn, a lifetime of the power supply mechanism 500 has also been effectively extended, thereby improving a durability of the electronic cigarette. Through the design of the detachable power supply mechanism 500, the user can carry multiple backup power supply mechanism (power supply module) 500, which can last longer when used outdoors, thereby meeting a need of long-term outdoor use.

Through a design of a detachable end cover 300, the user can easily disassemble and slide out the atomization mechanism 400 and power supply mechanism 500, which facilitates a maintenance and cleaning operation. Due to that the atomization mechanism 400 and power supply mechanism 500 are easily slid out, the user can replace different power supplies as needed. This flexibility allows the user to choose different atomization mechanism 400 and power supply mechanism 500 according to his personal preferences for a better user experience. Through a detachable design, the atomization mechanism 400 and power supply mechanism 500 can be easily replaced and upgraded. In this way, if one of the modules (atomization mechanism or power supply mechanism) fails or needs to be updated, the user can replace a single module (atomization mechanism or the power supply mechanism) without replacing the entire electronic cigarette, improving the durability and economy of the product. The detachable design makes the electronic cigarette more compact and portable. The user can disassemble the atomization mechanism 400 and the power supply mechanism 500 separately for easy portability and storage.

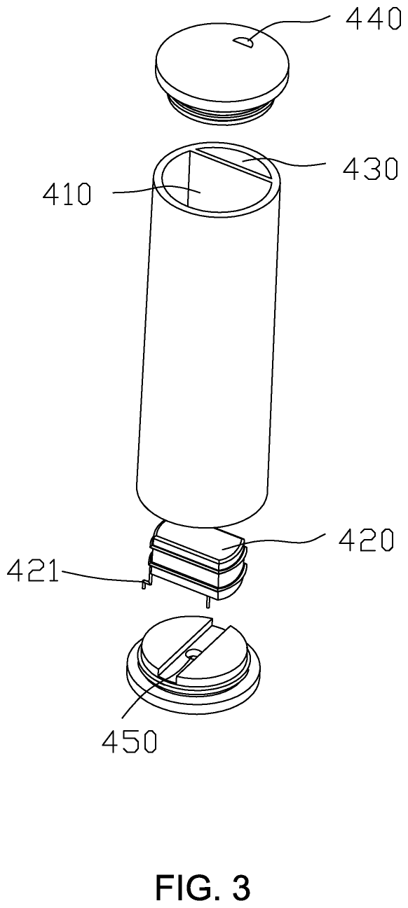

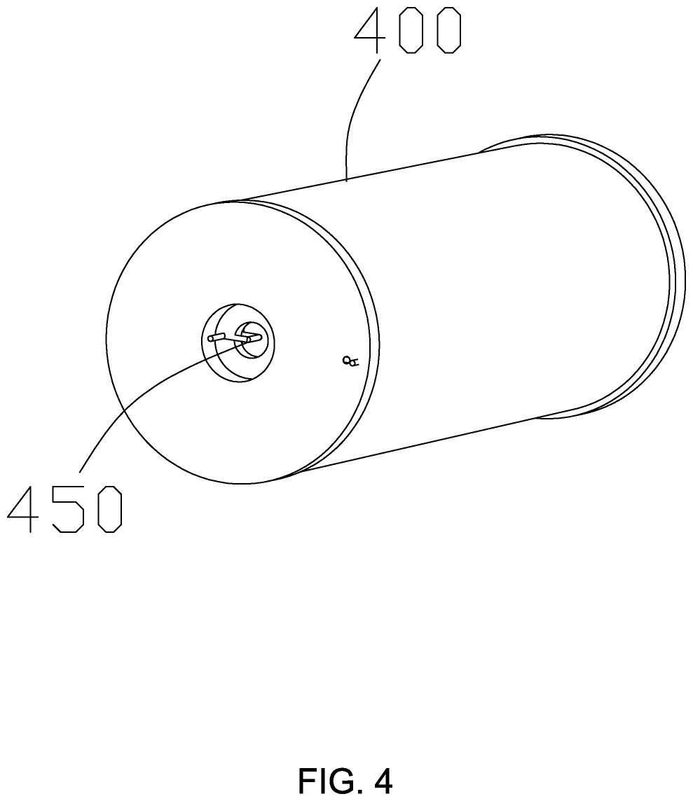

Referring to FIGS. 3-4, in this embodiment, the atomization mechanism 400 includes an oil storage bin 410, an atomization core 420, and an atomization channel 430. The atomization core 420 is connected to the atomization channel 430 and the oil storage bin 410;
one side of the atomization mechanism 400 close to the suction nozzle 200 is provided with a smoke outlet 440, one side of the atomization mechanism 400 close to the power supply mechanism 500 is provided with an air inlet 450. The atomization channel 430 is connected to the smoke outlet 440 and the air inlet 450.

When the user inhales the electronic cigarette, air enters the atomization channel 430 from the air inlet 450 on the side of the atomization mechanism 400 close to the suction nozzle 200. Meanwhile, tobacco oil is stored in the oil storage bin 410. When the power supply mechanism 500 is powered, the atomization core 420 will be heated, the tobacco tar is heated to an atomization point. Heated tobacco tar enters the atomization channel 430 through a hole of the atomization core 420 and is released from the smoke outlet 440 on one side of the atomization mechanism 400 close to the suction nozzle 200. Ultimately, the user inhales atomized tobacco tar, simulating the sensation and taste of traditional cigarettes. By heating the tobacco tar to the atomization point through the atomization core 420, efficient atomization of the tobacco tar has been achieved. This can provide better atomization effect and meet the needs of the user for taste and throat sensation. The atomization core 420 separates the atomization channel 430 and the oil storage bin 410, thereby avoiding a possibility of tobacco tar directly entering the suction nozzle 200. This separation design can reduce a risk of tobacco tar leakage and dripping into the suction nozzle 200, keeping the suction nozzle 200 clean and hygienic. One side of the atomization mechanism 400 close to the suction nozzle 200 is provided with a smoke outlet 440, one side of atomization mechanism 400 close to the power supply mechanism 500 is provided with an air inlet 450. This design separates the intake and exhaust channels, ensuring correct flow directions of the tobacco tar and air, and avoiding problems of backflow and tobacco tar leakage. Through reasonable design of intake and outtake and atomization effect, a better taste and smoking experience can be provided. The user can obtain richer and smoother smoke, which improves his satisfaction with usage.

In this embodiment, the oil storage bin 410 is made of a transparent material, a visual window 110 is provided on the shell 100. A position of the visual window 110 corresponds to a position of the oil storage bin 410.

When the user wants to know an amount of tobacco tar in his electronic cigarette, he can directly see the amount of tobacco tar in the storage bin 410 through the visual window 110 on the shell 100. The transparent oil storage bin 410 material makes it can be clearly seen the storage capacity of the tobacco tar, and the user can determine whether to add the tobacco tar according to his needs. The transparent oil storage bin 410 and the visible window 110 located on the shell 100 allow the user to directly observe the storage capacity of the tobacco tar without the need for disassembly or speculation. In this way, the user can arrange the addition and replacement of tobacco tar reasonably according to an actual situation, thereby providing convenience. Through the visual window 110, the user can promptly detect insufficient tobacco tar storage, avoiding an embarrassed situation of being unaware of tobacco tar consumption during use. In this way, the user can replenish the tobacco tar in a timely manner to ensure a continuous user experience. The transparent oil storage bin 410 and visible window 110 design enhance the user's sense of control and interactivity over the product. The user can have a clear understanding of the storage capacity of tobacco tar, thereby better planning the use and purchase of tobacco tar and improving the overall user experience.

In this embodiment, a conductive pin 421 of the atomization core 420 extends out of the atomization core 420 and abuts against an electrode of the power supply mechanism 500 to form conductivity, the end cover 300 abuts against the power supply mechanism 500 to maintain a connection between the electrode of the power supply mechanism 500 and the conductive pin.

The power supply mechanism 500 and the atomization mechanism 400 are powered through a contact type without a need for a wire connection. When the end cover 300 abuts against the power supply mechanism 500, the electrode of the power supply mechanism 500 form conductivity with the conductive pin of the atomization core 420. At this time, the power supply mechanism 500 is able to provide electricity to the atomization core 420 and atomize the tobacco oil by heating the atomization core 420.

Adopting a contact design of the power supply mechanism, there is no need to connect the power supply mechanism 500 and atomization mechanism 400 with wires, rendering the replacement of the power supply mechanism 500 more convenient. The user only needs to align and insert the power supply mechanism 500 with the atomization mechanism 400 to complete the replacement, eliminating a tedious cable connection step. Through the contact type of the power supply mechanism, the connection between the power supply mechanism 500 and the atomization mechanism 400 is more flexible. The user can choose different types or specifications of power supply mechanisms 500 according to his personal preferences and easily replace them. This design provides the user with more choices and scalability. Due to a lack of wire connection, maintenance and repair of electronic cigarettes have become more simplified. The user can easily disassemble the power supply mechanism 500 and atomization mechanism 400 for separate maintenance or replacement, reducing interference and complexity during the repair process.

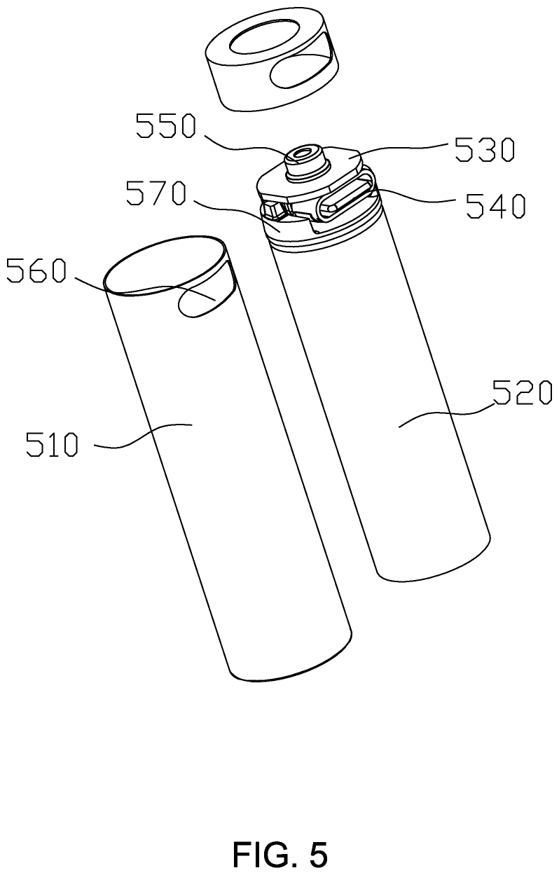

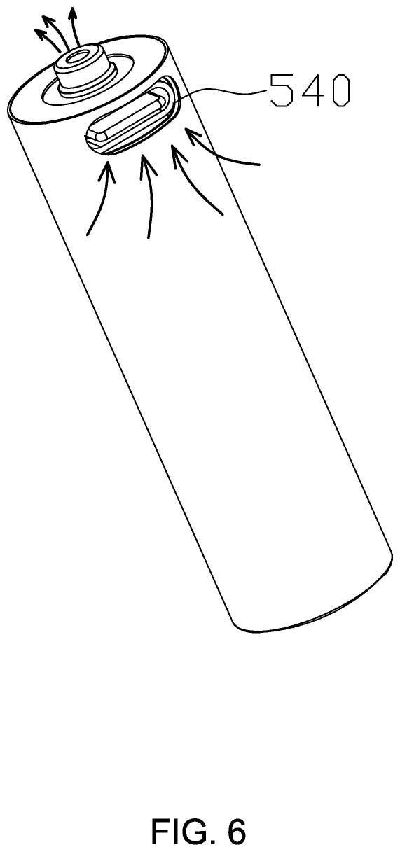

Referring to FIGS. 5-6, in this embodiment, the power supply mechanism 500 includes:
a power supply housing 510;
a battery cell 520, the battery cell 520 is provided in the power supply housing 510;
a control board 530, which is provided in the power supply housing 510. A base 570 is provided between the control board 530 and the battery cell 520. Due to uneven surface height of the control board 530, height difference is compensated by the base 570 to maintain stability between the control board 530 and the battery cell 520;
the control board 530 is provided with a charging port 540, the power supply housing 510 is provided with a through hole 560 corresponding to the charging port 540.

When charging the power supply mechanism 500, the user can insert a charger into the through hole 560 in the power supply housing 510 through the charging port 540. The charger supplies power to the battery cell 520 in the power supply mechanism 500 through the charging port 540 for charging. The control board 530 is responsible for monitoring a charging status of the battery cell 520 and stopping charging when a set battery level is reached. A through hole 560 corresponding to the charging port 540 is provided in the power supply housing 510, achieving convenient charging operations. The user only needs to directly plug in the charger to charge without disassembling the power supply mechanism 500 or using an external charger. The presence of control board 530 can monitor the state of battery cell 520 during the charging process and stop charging after reaching the set battery level, thereby ensuring the safety of charging. This can prevent the battery cell 520 from overheating or damage due to overcharging, thereby improving the safety of use. Designing the charging port 540 and through hole 560 into the hosing of the power supply mechanism 500 simplifies the design and manufacturing process. The user does not need to use a separate charger or disassemble the power supply mechanism 500, reducing the number of components and interfaces and improving overall simplicity and reliability.

In this embodiment, the control board 530 is provided with an air outlet 320, which is connected to the through hole 560 on the power supply housing 510 to form a first air passage;
the control board 530 is provided with an airflow sensor, the airflow sensor is located in the first air passage to monitor airflow. The control board 530 controls an external power supply of the power supply mechanism 500 based on signal of the airflow sensor.

A gap is formed between the through hole 560 on the power supply housing 510 and the charging port 540. When the user inhales an electronic cigarette, air enters the through hole 560 on the power supply housing 510 through the air outlet 320, and thus, an airflow is formed. The airflow sensor is located in the first air passage and can monitor intensity and changes of the airflow in real time. The control board 530 determines the user's inhalation behavior by receiving signals from the airflow sensor, and controls power supply mechanism 500 to the supply power to the electronic cigarette as needed. Through the signal from the airflow sensor, the control board 530 can monitor the user's inhalation behavior in real time. According to the suction intensity and changes, the control board 530 can intelligently adjust the power supply of the power supply mechanism 500 to the electronic cigarette. This can achieve more precise and user-friendly power supply control, providing a better smoking experience. Due to the fact that the control board 530 controls the power supply based on the user's inhalation behavior, it can prevent the electronic cigarette from continuously supplying power in a non-aspirated state. This can save energy on the power supply mechanism 500, extend the lifetime of the electronic cigarette and the power supply mechanism 500. Through intelligent power supply control, the electronic cigarette can better meet the user's inhalation habits and taste needs, providing a smoother and more comfortable smoking experience. The user can enjoy a smoking sensation that meets his own needs without any additional operation.

In this embodiment, the end cover 300 is provided with an air hole 320;
a gap is formed between the shell 100 and the atomization mechanism 400 with the power supply mechanism 500, the gap connects the air hole 320 and the through hole 560 on the power supply housing 510 to form a second air passage.

When the user inhales an electronic cigarette, air enters the through hole 560 on the power supply housing 510 from the air hole 320, and thus, an airflow is formed. A portion of the airflow enters the atomization channel 430 of the atomization mechanism 400 through the first air passages, mixes with the atomized tobacco tar to form smoke, and is finally discharged from the suction nozzle 200 for the user to consume. At the same time, another portion of the airflow enters the electronic cigarette from an outside through the second air passage, and exchanges with the outside air before mixing with the tobacco tar in the atomization channel 430, thereby maintaining a smooth airflow and stable smoke output.

In this embodiment, the air hole 320 of the end cover 300 is inwardly recessed. When the electronic cigarette is placed vertically, the recessed part of the end cover 300 will maintain a certain distance from a support surface. In this way, if there is tobacco tar or other stains accumulated on the electronic cigarette, they will not directly come into contact with the air hole 320. Therefore, a possibility of dirt accumulation causing blockage at the air hole 320 is reduced. A recessed design of the end cover 300 effectively reduces the blockage problem caused by the accumulation of dirt at the air hole 320. This can ensure the smoothness of the air hole 320 and ensure a normal suction and exhaust functions of the electronic cigarette. Due to a separation of the recessed part from the support surface, the accumulation of stains at the air hole 320 is reduced, rendering cleaning more convenient. The user can easily clean the electronic cigarette, keep it clean and hygienic. An occurrence of air hole 320 blockage can be reduced, the service life of electronic cigarette is prolonged. Blocked air hole 320 may cause difficulty in smoking or affect smoke output, by reducing a possibly of blockage, a normal function and performance of the electronic cigarette can be maintained.

In this embodiment, a type of the charging port 540 is type-c. When charging an electronic cigarette, the user can use a Type-C charging cable to connect the charger or power adapter to the Type-C charging port 540 of the electronic cigarette. The Type-C charging port 540 has characteristic of reversible insertion and removal and can be correctly connected regardless of an insertion direction.

Type-C charging port 540 is a universal charging interface widely used in various electronic devices. Therefore, the electronic cigarette with a Type-C charging port 540 has wider compatibility and can be charged with various Type-C chargers or power adapters. Type-C charging port 540 is one of trends for future mobile devices, gradually replacing traditional Micro USB charging port 540. The choice of Type-C charging port 540 makes the electronic cigarette compatible with future devices, maintaining the product's foresight and sustainability.

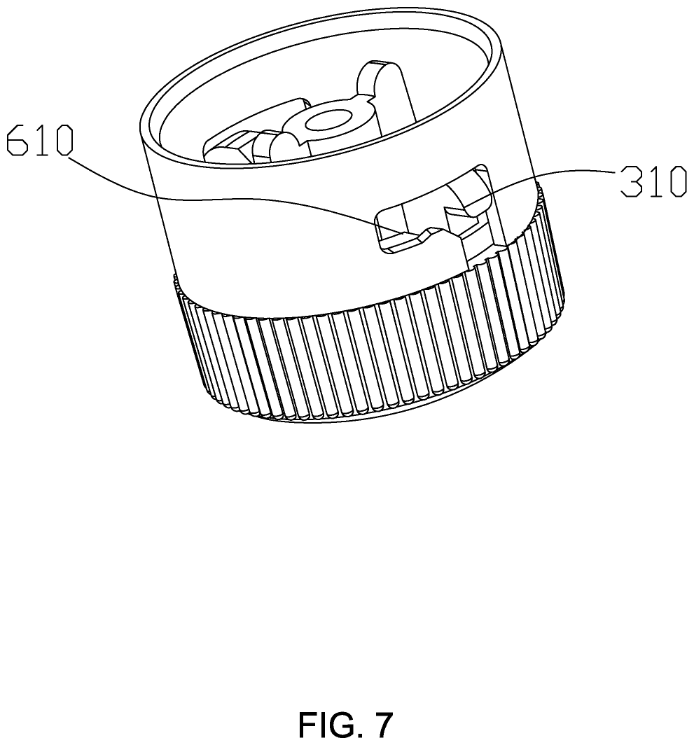

Referring to FIG. 7, in this embodiment, one side of the shell 100 close to the end cover is provided with a fixed ring 600 with a bending groove 610. The end cover 300 is located at an ear portion 310 of the bending groove 610, the end cover 300 is detachably connected to the shell 100 through the ear portion 310 matching with the bending groove 610.

When the user needs to disassemble or replace electronic cigarette components, he can do so by sliding the end cover 300 out of the bending groove 610. By matching the ear portion 310 with the bending groove 610, the end cover 300 can remain stable during a sliding process and can be detachably connected to the shell 100.

By designing the bending groove 610 and ear portion 310, the user can easily disassemble and replace electronic cigarette components, such as the power supply mechanism 500 and atomization mechanism 400. This facilitates maintenance, cleaning, and component replacement operations, improving the maintainability and reliability of the electronic cigarette.

Finally, it should be noted that the above is only embodiments of the present disclosure and is not intended to limit it. Although the present disclosure has been described in detail with reference to the aforementioned embodiments, it is still possible for those skilled in the art to modify the technical solutions recorded in the aforementioned embodiments or to equivalently replace some of their technical features. Any modifications, equivalent replacements, improvements, etc. made within the spirit and principles of the present disclosure shall be included within the protection scope of the present disclosure.

What is claimed is:

1. An electronic cigarette with a detachable battery, comprising:
a shell, which is provided with a cavity that runs through two ends, one end of the shell is provided with a suction nozzle, the other end thereof is detachably provided with an end cover;
an atomization mechanism, wherein the atomization mechanism is located at one side of the cavity close to the suction nozzle, the atomization mechanism is connected to the suction nozzle;
a power supply mechanism, wherein the power supply mechanism is provided in the cavity and is electrically connected to the atomization mechanism;
wherein, after disassembling the end cover, the atomization mechanism and the power supply mechanism can slide out from the cavity of the shell, and the end cover abuts against the power supply mechanism to fix the atomization mechanism and the power supply mechanism in the cavity of the shell.

2. The electronic cigarette with a detachable battery according to claim 1, wherein the atomization mechanism comprises an oil storage bin, an atomization core, and an atomization channel, wherein the atomization core is connected to the atomization channel and the oil storage bin;
one side of the atomization mechanism close to the suction nozzle is provided with a smoke outlet, one side of the atomization mechanism close to the power supply mechanism is provided with an air inlet; the atomization channel is connected to the smoke outlet and the air inlet.

3. The electronic cigarette with a detachable battery according to claim 2, wherein the oil storage bin is made of a transparent material, the shell is provided with a visible window, a position of the visible window corresponds to a position of the oil storage bin.

4. The electronic cigarette with a detachable battery according to claim 2, wherein a conductive pin of the atomization core extends out of the atomization core and abuts against an electrode of the power supply mechanism to form conductivity, the end cover abuts against the power supply mechanism to maintain a connection between the electrode of the power supply mechanism and the conductive pin.

5. The electronic cigarette with a detachable battery according to claim 2, wherein the power supply mechanism comprises:
a power supply housing;
a battery cell, wherein the battery cell is provided in the power supply housing;
a control board, wherein the control board is provided in the power supply housing;
wherein the control board is provided with a charging port, the power supply housing is provided with a through hole corresponding to the charging port.

6. The electronic cigarette with a detachable battery according to claim 5, wherein the control board is provided with an air outlet, the air outlet is connected to the through hole on the power supply housing to form a first air passage;
the control board is provided with an airflow sensor, the airflow sensor is located in the first air passage to monitor airflow; the control board controls an external power supply of the power supply mechanism according to signal of the airflow sensor.

7. The electronic cigarette with a detachable battery according to claim 6, wherein the end cover is provided with an air hole;
a gap is formed between the shell and the atomization mechanism with the power supply mechanism; the gap connects the air hole and the through hole on the power supply housing to form a second air passage.

8. The electronic cigarette with a detachable battery according to claim 7, wherein the air hole of the end cover is inwardly recessed.

9. The electronic cigarette with a detachable battery according to claim 5, wherein a type of the charging port is type-c.

10. The electronic cigarette with a detachable battery according to claim 1, wherein one side of the shell close to the end cover is provided a fixed ring with a bending groove, the end cover is located at an ear portion of the bending groove; the end cover is detachably connected to the shell by the ear portion matching with the bending groove.
